(19) United States
(12) Patent Application Publication
(10) Pub. No.: US 2007/0198327 A1
(43) Pub. Date: Aug. 23, 2007

(54) Systems and methods for measuring, targeting, verifying, and reporting advertising impressions

(76) Inventors: Amir Yazdani, Portland, OR (US); Chris Behnke, Gresham, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/701,959

(22) Filed: Feb. 1, 2007

Related U.S. Application Data
(63) Continuation-in-part of application No. 10/641,792, filed on Aug. 15, 2003.
(63) Continuation-in-part of application No. 11/257,578, filed on Oct. 24, 2005.
(60) Provisional application No. 60/764,439, filed on Feb. 1, 2006.

(51) Int. Cl. G06Q 10/00

(52) U.S. Cl. 705/10

(57) ABSTRACT

Systems and methods are disclosed that enable an advertising or marketing company to identify with greater particularity the shows, movies, channels, entertainment commodity, commodity distribution channel, etc. in which they should place their ad for greatest effect, that is to attain the desired number of impressions in by the desired target audience. The present system and methods may also enable an advertising or marketing company to determine where to send their ads for greatest effect. By characterizing devices that receive or play entertainment commodities, an advertiser may be able to predict that the viewer of entertainment commodities and ads at that device would have particular characteristics that may be within or without the target audience. The systems and methods of the present disclosure enable an advertiser to characterize the viewer of the advertisement without collecting personal information or personally identifiable information from the view, the supplier of the entertainment commodity, or other source of personal information.

### CROSS-REFERENCES TO RELATED APPLICATIONS

This application is a continuation-in-part application of U.S. patent application Ser. No. 10/641,792 filed on Aug. 15, 2003, entitled “Business Transaction Reporting System” and Ser. No. 11/257,578 filed on Oct. 24, 2005, entitled “Systems and Methods for Measuring Consumption of Entertainment Commodities.” This application claims priority to U.S. Provisional Patent Application Ser. No. 60/764,439, entitled “Systems and Methods for Measuring, Targeting, Verifying, and Reporting Advertising Impressions.” The entire disclosures of all of these are incorporated herein for all purposes.

### FIELD OF THE INVENTION

The present disclosure is related to systems and methods of measuring advertising impressions, targeting advertisement placement, verifying advertisement impressions, and reporting advertisement impressions.

### BACKGROUND

Entertainment is a major industry in America and many other countries. One primary entertainment media is through television shows, movies, and music. Additionally, companies interested in selling products have been advertising those products in connection with the entertainment industry for many years. One common form of advertising includes placing advertisements (or, as may be used herein interchangeably, ads) before, after, or during a show or movie, or between songs on a radio or other device for playing music. Examples of such advertisements are well known in television, movie theaters, and radio markets. In recent years, advertisements within an entertainment commodity, such as a television show or a movie, have changed slightly to include advertisements in commercial breaks and advertisements that appear in a portion of the screen while the movie or show is still showing. In general, the advertisements associated with these entertainment commodities can be front or rear bumpers shown or played before or after the commodity, respectively; inserts shown during commercial breaks, which may be embedded ads carried with the commodity, showcase ads provided on a local or provider level, and/or dynamic ads inserted to target particular consumers based on one or more factors.

Advertisers generally pay large sums to have their ads shown or played in cooperation with the more preferred entertainment commodities. For example, the price of a 30 second advertisement during the Super Bowl has seen incredible increases in recent years. However, advertisers have relatively little input to determine where to place the ads, how to place their ads, or when to place their ads to market their product most effectively to their determined target audience. Generally, the advertiser is concerned with the number of impressions of the advertisement. The advertisement impressions are the number of times it is seen by the public. For example, the advertising impressions of an ad during a commercial break of a sitcom would be the number of televisions that were tuned to that sitcom during the period in which the advertisement was shown. For a given advertising campaign, the advertiser is often interested in the total impressions for the campaign, or the sum of the impressions for each of the different advertising spots in which the ad was carried. In some campaigns, the ad may be carried in television shows, movies, radio, or other media distributions, such as portable devices, internet, and cell phone distribution. For example, an ad or trailer for a new movie may be distributed to the public in any one of these methods or more. Therefore, the total advertisement impressions for a campaign may include impressions from a number of different media formats, distribution methods, and even different ads within the same campaign. While advertisers are interested in these impressions, their ability to predict where to best place their ad and to know that their ad was watched is currently limited.

For example, an advertiser of a product for a new woman's hygiene product may assume, rightly or wrongly, that advertising during the Super Bowl would not be the best use of the funds. However, other products and entertainment commodities do not present such stark contrasts. The decision making for such advertisements is often guided by the advertiser's experience, intuition, or best guess rather than on supported records. Moreover, the advertiser receives very little information regarding the actual number of impressions for a given ad in a given ad placement in an entertainment commodity. For some ads, there are surveys that sample small portions of the consuming public and extrapolate to estimate the total viewership of a given commodity. That estimated viewership is then used to determine the number of impressions of the ads within the commodity. The prices for the advertising spots are often based on these estimations and the advertiser is left to trust the assumptions of the surveyor. Despite the efforts of the surveyors to create a representative and suitable sample group and to make suitable assumptions, a more complete survey would generate more reliable measurements or estimates.

Advertisers will be better able to determine where to place their ads and how much the ads should cost if they had better data on the viewership of particular shows or commodities or the viewership of particular networks or distribution methods. For example, while an accurate measurement of advertisement impressions is valuable to the advertisers, an accurate measurement of advertisements impressions that were viewed by the target audience is even more valuable.

### SUMMARY

Systems and methods are disclosed that enable an advertising or marketing company to identify with greater particularity the shows, movies, channels, entertainment commodity, commodity distribution channel, etc. in which they should place their ad for greatest effect, that is to attain the desired number of impressions in by the desired target audience. The present system and methods may also enable an advertising or marketing company to determine where to send their ads for greatest effect. By characterizing devices that receive or play entertainment commodities, an advertiser may be able to predict that the viewer of entertainment commodities and ads at that device would have particular characteristics that may be within or without the target audience. The systems and methods of the present disclosure enable an advertiser to characterize the viewer of the advertisement without collecting personal information or personally identifiable information from the view, the supplier of the entertainment commodity, or other source of personal information.

### BRIEF DESCRIPTION OF THE DRAWINGS

FIG. 1 is a block diagram showing interconnections between a variety of elements in an entertainment commodity and advertisement distribution system including an ad impression targeting and tracking system according to the present disclosure.

FIG. 2 is a schematic flow chart showing an exemplary logic diagram that may be used in an ad impression targeting and tracking system according the present disclosure.

FIG. 3 is a view of an exemplary program profile detail screen according to the present disclosure.

FIG. 4 is a view of an exemplary target audience selector screen according to the present disclosure.

### DETAILED DESCRIPTION

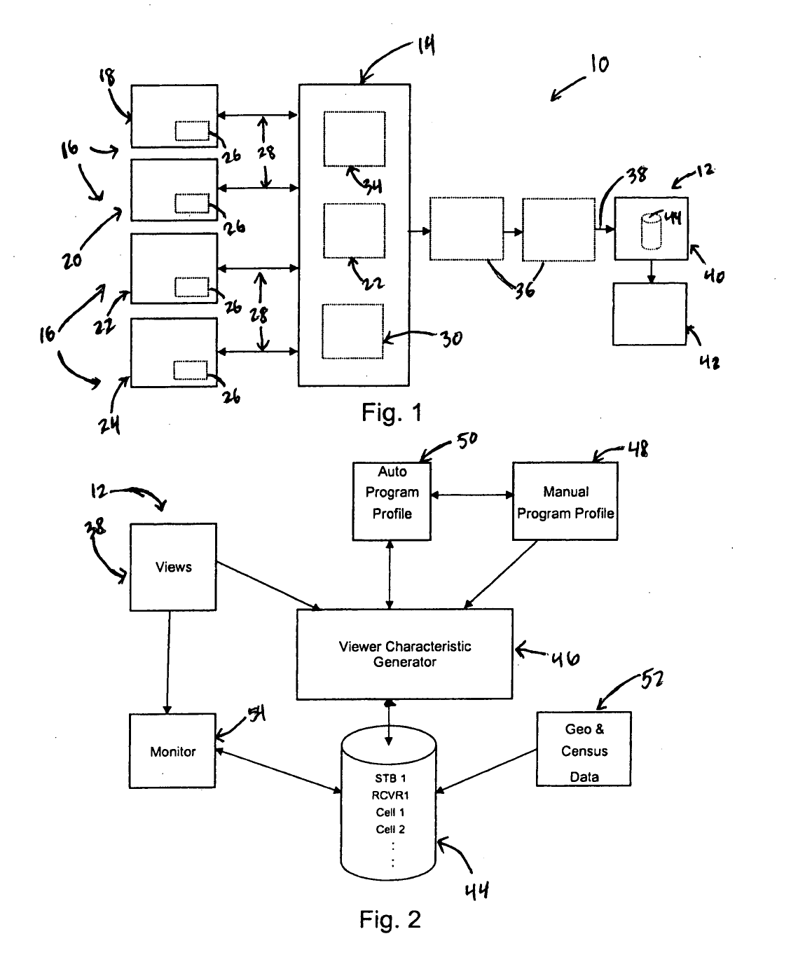

FIG. 1 provides an exemplary schematic view of an ad impression targeting and reporting system 12 in cooperation with other elements of an entertainment commodity and advertisement distribution system 10. As illustrated, the distribution system 10 includes a distributor 14 that provides entertainment commodities and associated advertisements to consumers 16. Consumers 16 represent viewers or consumers of the entertainment commodity and/or advertisement and may receive the advertisement through any suitable means, such as television, movies, cell phones, internet, or other devices adapted to playback entertainment commodities and/or advertisements. The distribution may be through traditional over-the-air networks, cable or satellite systems, wired or wireless internet systems, etc. Moreover, the distribution may be through linear systems such as television and radio or may be provided to the consumer with on or more features to enable customization of the delivery, such as on Demand viewing, digital video recording technologies, or other such systems as may be developed. As shown in FIG. 1, consumers 16 include at least one cable set-top box 18, a cell phone 20, a computer 22, and a satellite set-top box 24. Moreover, each of these consumer devices 16 may include one or more hard drives 26 or other internal components that enables the consumer to select the commodity to be watch, to time-shift the program, and/or to provide other customization to the playback.

FIG. 1 illustrates a single distributor 14 distributing content to consumers 16 of a variety of configurations. It is within the scope of the present disclosure that multiple distributors may distribute one or more types of content, including entertainment commodities and advertisements, to the consumers and that each consumer may receive content from one or more distributors, such as a computer that is adapted to receive content from a cable provider and an internet provider. Depending on the nature of the distributor 14, the distributor may be configured in a number of suitable manners and may include components 30, such as hard drives, servers, broadcasters, etc., to enable distribution of the media content to the consumers 16 via communication channels 28. As discussed above, communication channels 28 may be any suitable channel for distributing the entertainment commodity and advertisement.

The distributor 14 is further adapted to receive data from the consumers 16. For example, the distributor 14 may be configured to receive orders or requests from the consumers. Additionally or alternatively, the distributor may be adapted to monitor the condition of the consumers 16 periodically. Additionally, the distributor may be adapted to receive periodic reports from the consumers 16. Such communication between the distributor 14 and the consumers 16 may occur via the same communication channels used for distribution of the content or via other suitable communication channels. For example, a provider of satellite television may distribute the content via satellite and receive reports from the consumer via a standard telephone connection. In some configurations, the distributor may receive data related to linear content distribution and/or related to customized content distribution. The distributor 14 may be adapted to store linear data 32 separate from customized data 34 or may store them all together.

The distributor 14 is further illustrated as communicating data to one or more optional processes 36, which may occur within or be performed by the distributor or which may be performed by another entity contracted to provide an interface between the distributor 14 and the ad impression targeting and tracking system 12. The optional processes 36 may include such steps as cleaning the data from the distributor of unnecessary information, purging confidential information from the distributor data, reconciling data provided by multiple distributors, or other similar data process to prepare the data for use by the ad impression targeting and tracking system 12. The data 38 input to the ad impression targeting and tracking system 12 may include a variety of information, such as a consumer unit identifier, the time the content or commodity was watched, the name of the show that was watched, etc. Suitable methods and systems for providing the input data to the ad impression targeting and tracking system 12 is disclosed in U.S. patent application Ser. No. 11/257,578, entitled Systems and Methods for Measuring Consumption of Entertainment Commodities, and filed on Oct. 24, 2005, the disclosure of which is incorporated herein by reference in its entirety for all purposes.

Ad impression targeting and tracking systems 12 within the scope of the present disclosure may include an inferential engine 40 that receives the input data 38 and a reporting interface 42 that extracts data from the inferential engine and presents it in a desired report format. The inferential engine may include one or more programs and/or algorithms for processing the input data 38. Moreover, the inferential engine 40 includes an inferential database 44 configured to store data regarding one or more consumers 16 from whom input data has been collected, as discussed above.

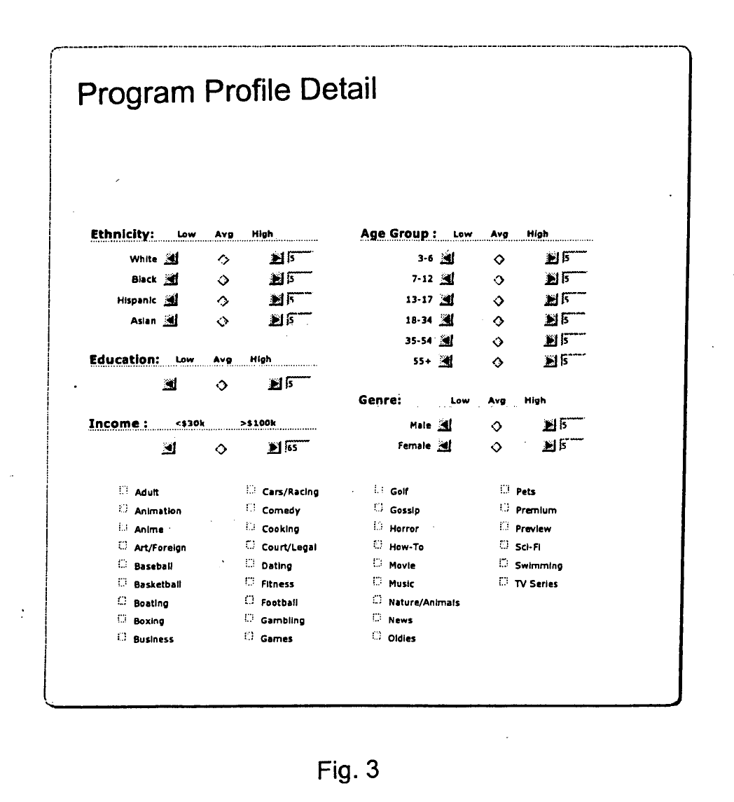

FIG. 2 illustrates in greater detail a schematic view of an ad impression targeting and tracking system 12, also referred to herein for convenience as the ad impression system 12. The ad impression system 12 includes the inferential database 44 introduced above. The inferential database 44 is adapted to store consumer identifiers, such as mac addresses, IP addresses, or other identifiers that uniquely identify the device on which the content was played or viewed without identifying the individual or persons using the consumer device and without storing personal information or personally identifiable information. For example, the inferential database 44 may store data regarding consumer devices, such as one or more set-top boxes, one or more receivers, one or more cell phones, etc. The type of data stored on the inferential database about each of these consumer devices 16 will be understood by the discussion herein.

As discussed above, the ad impression system may receive data input from a number of sources. One such source may include distributors or the systems described in U.S. patent application Ser. No. 11/257,578, previously incorporated herein. The data input 38 generally will include a listing of the views, downloads, or other playbacks of the entertainment commodity or advertisement, as suggested by FIG. 2. The ad impression system 12 may further include a viewer characteristic generator 46 adapted to receive the data input 38, to process that data, and to provide viewer characteristic data for each consumer 16 to the inferential database 44. FIG. 2 represents schematically a suitable configuration for the ad impression system 12; additional or fewer elements may be present in other ad impression systems within the scope of the present disclosure. For example, multiple viewer characteristic generators may be used to accommodate a greater number of consumers. Similarly, multiple databases, monitors, or other components may be used to scale the system to the appropriate level of data input.

The viewer characteristic generator 46 may include databases, algorithms, processes, programs, or other suitable components to enable it to generate the required data for the inferential database, such as will be better understood by the discussion herein. The viewer characteristic generator 46 may receive additional inputs from one or more of a manual program profiler 48 and an automatic program profiler 50. The program profilers 48,50 may include software, programs, input screens, etc. to enable entertainment commodities or “programs” to be profiled. An exemplary view of a program profile detail page is shown in FIG. 3. As illustrated, the program profile may include a variety of demographic variables, including age, education, income, etc. Additionally or alternatively, the program profile may include interest identifiers to associate a particular program with particular hobbies or interest groups.

The program profile may be created manually or automatically, by the manual or automatic profiler respectively. Beginning with the manual profiler, one or more programs may be profiled or detailed by any suitable person by entering the appropriate information into a computer program or database, which may be locally hosted or hosted on web-based interface. The profiled programs may be stored in a database in the manual program profiler or may be communicated to the viewer characteristic generator for storage. In either event, the viewer characteristic generator may have access to the profiles thus created. Additionally or alternatively, the manual program profiler may be adapted to profile an entire network or distribution method. For example, a television with a very narrow range of programming may be manually programmed to always provide entertainment commodities that are associated with a particular interest group. One such example might include a golf channel that can be manually profiled as always provided content related to golf.

The manual profiling of a channel, such as a golf channel, is one example of how an automatic program profiler would operate. The automatic program profiler assigns program profiles to programs based on information obtainable from within the ad impressions system. For example, after the channel has been manually profiled to always be related to golf, the auto program profile may be able to automatically profile all shows on that channel as related to golf. Accordingly, the manual program profiler may communicate with the automatic program profiler. Moreover, the viewer characteristic generator may communicate with the automatic program profiler to both send and receive data. For example, the viewer characteristic generator may receive program profiles from the auto profiler and may also communicate viewing trends to the automatic profiler to help establish additional automatic profiles that may be applied.

The viewer characteristic generator 46 may be adapted to receive data from the profilers 48, 50 and may be adapted to receive input data 38 related to the views on each of the consumer 16 devices. Based on the data received by the viewer characteristic generator 46, the generator 46 may assign characteristics to each consumer 16 and send such characteristics to the inferential database 44. In some configurations, the inferential database 44 and the viewer characteristic generator 46 may be integrated or otherwise in operative communication. As indicated above, the inferential database 44 may store consumer identifiers and indicators of the consumer characteristics, without actually identifying the persons associated with the consumer device. For example, for each consumer 16, the inferential database 44 may include a plurality of checkboxes or flags for different viewer characteristics. As the viewer characteristic generator determines that a given consumer has or does not have a particular characteristic, the appropriate flag may be changed accordingly to maintain an inferred consumer characteristic for each consumer.

Between the viewer characteristic generator 46 and the inferential database 44, the ad impression system 10 may include programs or algorithms to cross-check the characteristic inferences to avoid characterizing the consumer based on anomalies or limited-time viewing patterns. Moreover, a monitor 54 may be provided that is adapted to check the characteristics in the inferential database 44 against the current viewing patterns. The monitor 54 may be a separate component and program or may be included as part of the inferential database and/or viewer characteristic generator.

An example of the ad impressions system 12 in operation may help illuminate the features and functions of the viewer characteristic generator 46 and the inferential database 44. As a consumer 16, such as a set-top box, is used to watch television over time, the shows, times, and other data (such as trick-mode data) of that consumer are communicated to the viewer characteristic generator along with a consumer device index, which is not personally identifying. The unique but non-identifying consumer device index is stored on the inferential database and a number of blank checkboxes or datafields are associated with the consumer device index. As the particular shows that are watched are compared to the program profiles, the viewer characteristic generator begins to make assumptions regarding the characteristics of the persons using the consumer device. For example, as the generator 46 observes 75% of the shows watched include a children's theme the generator may check the data field indicating that the consumer device is used by a person that has children or that has an interest in children's goods or themes. Similarly, if the generator observes that the consumer device is never active between 7:00 am and 6:00 pm from during the week, but is active during those times on the weekend, the ad impression system 12 may check the data field in the inferential database to indicate that the persons using the consumer device generally work during normal business hours. The number of inferences that can be made based on the viewing patterns coupled with the program profiles are only limited by the needs of the advertisers to identify a target marketing characteristic.

As suggested above, the ad impression system 12 may include controls to maintain the integrity of the inferential database 44 in spite of anomalies in viewing patterns. For example, if a particular consumer device has a history of viewing shows only at nights and shows that are not directed towards children, the inferential database may have established a characteristic of ‘working with no children in the home.’ If there is a week of viewing habits in which the viewing pattern changes to watching a great deal of television during the day directed towards children's themes, the ad impression system 12 may have a monitor system or an characterization integrity check that delays altering this characterization until the viewing patterns are persistent enough to indicate a change in persons using the consumer device rather than just a visitor at the home. In the above example, the change in viewing habits for one week may be attributable to a nephew or grandchild visiting the home rather than an actual change in the persons associated with the consumer device.

In some aspects of the present disclosure, the ad impressions system 12 may be adapted to enhance the integrity of its characterizations by assigning each characterization a confidence value. For example, if a consumer device watches one show that is profiled to be watched by viewers interested in cooking, the cooking data field may be populated with an indicator that the consumer device has this characteristic with a confidence of 5%. As more shows profiled as cooking shows are watched by the same consumer device, the confidence level will increase. Accordingly, the characterizations of a particular consumer device may evolve over time to adapt to the changing character of the viewers.

One common example of a viewer characteristic that may change over time is when a young family has their first child. Prior to the birth of the child, the ad impressions system 12 and inferential database 44 may have characterized the viewers as young, working adults, perhaps with interests in outdoors, golf, cars, or other such activities. After the birth of the child, the viewing habits may change to include shows on parenting and then toddler programming, etc. Over time, the ad impressions system 12 will observe this change in viewing patterns and adjust the characterization of the consumer device accordingly.

FIG. 2 further illustrates that the inferential database may receive data inputs from sources other than the viewing habits of the consumer device. For example, the consumer device may be associated with a particular zip code or other geographical area without providing any personally identifying information. The zip code or other geographical indicator may be associated with demographic or census data to provide additional information about the persons using the consumer device. For example, the geographical indicator may provide insight into the home value where the consumer device is used, the income level or education level of the persons using the consumer device, or other demographic data about the viewers. This data may be used in a manner similar to the data generated by the viewer characterization generator to provide data for the inferential database.

As can be seen in FIG. 2 many of the components of the inferential engine are adapted to have two-way communication with other components. For example, the inferential database 44 and the viewer characteristic generator 46 may be in two-way communication. Similarly, the automatic program profiler 50 and the viewer characteristic generator 46 may be in two-way communication. One advantage of the two way communication with the automatic program profiler is that the auto profiler may be able to learn over time that certain programs are likely to be watched by persons having particular characteristics. For example, assuming there is a show that is not profiled that is watched by a number of consumers. Without a profile for that program, it is not able to influence the characterization of the viewers. However, if the inferential database 44 and viewer characteristic generator 46 determine that the show is watched only by households that have a common characteristic, the ad impression system 12 may cause the auto profiler to profile that show as related to viewers with that characteristic; such profiling may be marked as tentative or otherwise marked as needing verification. Over time or depending on the strength of the inferences, more and more shows may be automatically profiled based on the characteristics of the viewers in the inferential database.

With reference to FIGS. 1 and 2, the inferential database 44 and the inferential engine 40 may be adapted to produce a database of information regarding the characteristics of the viewers using particular consumer devices. The ad impressions system 12 may further provide a reporting engine 42 adapted to extract information from the inferential engine and present it to the user in customizable reports. For example, the reporting engine 42 may provide a report of the consumer devices in a particular geographic region that are baseball fans. Similarly, a report of what shows are watched by viewers that are also baseball fans or what time of day an advertiser would be most likely to have their ad seen by a working woman may also be generated. Any suitable combination of viewer characteristics may be used to prepare a report for use by advertisers or others interested in communicated with a target audience have particular characteristics.

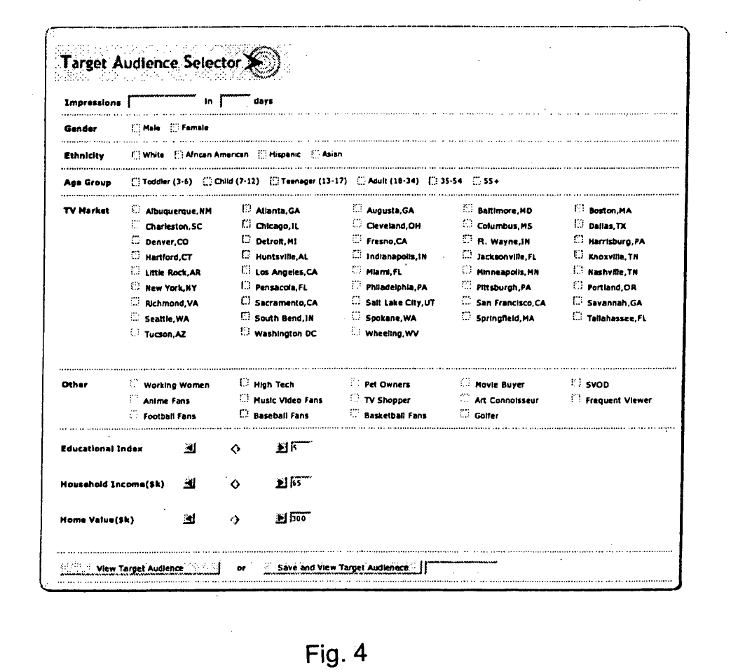

FIG. 4 illustrates a screen shot of an exemplary target audience selector interface that may be run locally or hosted remotely to provide a user with a report of how to best communicate with their target audience. In one exemplary use, the user would select the characteristics of the target audience, such as television markets and basketball fans with teenagers in the home. The report would then generate a list of the shows, programs, channels, or distribution methods that would be most likely to communicate with that target audience. In some aspects, the reporting engine and target audience selector may enable the user to select the number of impressions desired within a particular time period. The target audience report may include information about the past viewership of that show, the projected viewership of that show, the quality or integrity of the match (such as how likely a particular program is to be viewed by a teenager), or other information to help the user understand the likelihood of communicating to the target audience with the desired number of impressions.

Additionally or alternatively, the reporting engine 42 may generate a target audience report that is specific as to time and consumer device. For example, the inferential database 44 includes viewing characteristics of each consumer device and an index to help identify the device without identifying the audience personally. Based on the target audience selections on the target audience selector, the report generator may provide a listing of the consumer devices that have viewers matching those characteristics and in what shows you would be most likely to communicate that ad to that viewer. A report that is this specific in nature would benefit both the consuming public and the advertiser. The advertiser would know that his advertising dollars are not being wasted and the consumer would be less inclined to fast forward through ads because the ads are actually relevant to him/her. Such focused advertising is possible through dynamic ad placement in which the distributor is able to selectively send ads to specific consumer devices. The technology to support dynamic advertising is still in its early stages of development and its availability is dependent on the distribution channels used. However, as the communication technologies continue to advance, dynamic ad placement and other methods of more focused advertising will be more readily available. The ad impressions system 12 of the present disclosure will provide the detailed reports necessary to make the dynamic advertising valuable to advertisers and consumers.

In some aspects of the present disclosure, the ad impressions system 12 may be adapted to further provide reports of the best type of ad to use for your advertising campaign. As discussed previously, there are a number of ad types, including bumpers (front and rear), inserts (embedded, showcase, and dynamic), and overlays. In ad impression systems 12 adapted to receive input data that includes trick-mode data, such as pauses, fast-forwards, etc., the viewer characteristics logged by the inferential engine may include data regarding responses to advertisements. The inferential engine 40 may include data inputs regarding what shows were aired when, when the ads were placed aired in relation to the show, and what type of ad it was. By matching the trick mode data with the data regarding the timing of the ads within the show, the ad impression system 12 may further be able to determine which ads get skipped the most, which ads get replayed by rewinding to see the ad again, which types of ads get skipped, what types of ads get skipped based on the genre of the associated entertainment commodity, etc. For example, the trick mode data and correlated data regarding entertainment commodities and advertisement placement may indicate that front bumpers and rear bumpers are frequently skipped by viewers, but that the first and last ads in a commercial break are often view, at least partially. Moreover, the data may show that overlay ads are effective in sports programming but not effective in dramas or love stories, for example.

As described above, the advertisement impressions targeting and tracking system 12 according to the present disclosure may provide methods and systems for targeting ads to particular shows and/or to particular consumer devices. Additionally or alternatively, the advertisement impressions system 12 of the present disclosure may provide systems and methods for tracking the impressions of an advertisement, which may be used to verify the estimates provided in the targeting phase and/or to improve the estimates provided by the targeting systems. As described above, the ad impression system 12 receives data inputs showing what shows are watched when by particular consumer devices and has characterized those consumer devices accordingly. The characterization of the device may be static or dynamic as described above and may include multiple characterizations based on time-of-day, such as children's programming during the day and adult programming in the evening. Additionally, the ad impressions system 12 may include data inputs regarding what ads are displayed in the shows, at what times those ads are presented, and what type of ad is presented. By correlating the data regarding the entertainment commodity actually watched and the advertisement placements within the shows, the ad impressions system 12 may be adapted to produce data regarding the number of impressions of a given ad. Additionally, in combination with viewer characterizations stored in the inferential database 44, the ad impressions system may be adapted to produce reports relating the total impressions and the characteristics of the viewers of those impressions, such as 100,000 impressions, 75% of which were by consumer devices believed to have children in the home.

The detail available in the reports of the ad impression system's impression reporting function is limited only by the characteristics included in the inferential database. Accordingly, a user may be able to use the targeting function of the ad impression system to determine a strategy for attaining the desired number of impressions by a target audience and then may use the impression reporting function to determine whether the desired number of impressions were attained and what the character of the viewers were. Both features are of great value to product marketers and advertisers as they develop marketing strategies and determine how to spend their advertising dollars.

The advertisement impression systems of the present disclosure and the methods of using the same to produce both targeting and measuring reports may be adapted to improve in accuracy over time. As more and more shows are profiled and as the characteristics of viewers become more reliable through continued recording of the viewing patterns, the inferential database and viewer characteristic generator will improve in accuracy and reliability. Additionally, as targeting reports are generated and measurement reports are generated to verify the accuracy of these targets, the inferential engine may be adapted to learn from the measured results to improve its targeting. The two-way communication between the several components may facilitate or cooperate in the ability of the ad impression system 12 to learn and improve in accuracy and reliability over time.

In much of the discussion herein, the ad impression system 12 was discussed in the context of commercials seen on television. However, as suggested in the beginning, the present systems and methods are applicable for any form of advertisement distribution. For example, movies, music videos, and TV shows are being distributed in new distribution channels and formats seemingly monthly. To the extent that an entertainment commodity can be distributed to a view, the present systems and methods can be used to assist in the targeting and measuring of the advertising that may be associated with such distribution. For example, a cell phone user may prefer to endure a 15 second ad about a product he is actually interested in before receiving a free music video download rather than having to pay for the music video. Similarly, several companies are now offering television shows for limited download or playback over the internet or portable devices. Currently, consumers are generally required to pay for such distributions. However, through targeted advertising available through the methods and system of the present disclosures, advertisers may be able to confidently place their ads in these distributions to reduce the cost to the consumer. Accordingly, it should be understood that that present disclosure is not limited to advertisements incorporated in television shows.

We claim:

1. A method of reporting impressions of advertisements associated with distributed media assets, the method comprising:
collecting media asset perception data from at least one media asset distributor;
collecting advertisement placement data including information regarding relationships between at least one advertisement and one or more of the distributed media assets;
loading the collected media asset perception data and the collected advertisement placement data into at least one computerized database; and
generating advertisement impression data by correlating at least the collected media asset perception data and the collected advertisement placement data; and
producing at least one advertisement impression report based at least in part on the advertisement impression data.

2. The method of claim 1, wherein the collected media asset perception data includes at least one type of information regarding perceptions of one or more distributed media assets selected from times of the perceptions and methods of receiving the distributed media asset.

3. The method of claim 2, wherein the information regarding the time of the perception includes at least one type of information selected from dates of the perceptions, days of the week of the perceptions, times of day of the perceptions, and durations of the perceptions.

4. The method of claim 2, wherein the information regarding the method of receiving the distributed media asset includes at least one type of information selected from networks on which the media asset was perceived, system operators from whom the media asset was received, television markets in which the media asset was received, types of media receiver through which the media asset was perceived, operating modes of the media receiver through which the media asset was perceived, and unique media receiver codes adapted to distinguish and identify media receivers without revealing personally identifiable information.

5. The method of claim 1, wherein the method further comprises collecting environmental data on at least one audience environment factor, and wherein the at least one advertisement impression report is based at least in part on the environmental data.

6. The method of claim 5, wherein generating advertisement impression data includes correlating at least the collected media asset perception data, the collected advertisement placement data, and the collected environmental data.

7. A method of reporting impressions by a target audience of advertisements associated with distributed media assets, the method comprising:
collecting media asset perception data from at least one media asset distributor;
collecting advertisement placement data including information regarding relationships between at least one advertisement and one or more of the distributed media assets;
collecting at least one target audience profile from an advertiser identifying at least one characteristic of a target audience for one or more advertisements;
loading at least the collected media asset perception data, the collected advertisement placement data, and the at least one target audience profile into at least one inferential database;
generating one or more media asset profiles identifying at least one characteristic of a perceiving audience of the one or more distributed media assets and loading the one or more media asset profiles into the at least one inferential database;
generating target audience impression data with an inferential engine associated with the inferential database by correlating at least the collected media asset perception data, the collected advertisement placement data, the collected at least one target audience profile, and the one or more media asset profiles; and
producing at least one target audience impressions report based at least in part on the target audience impression data.

8. The method of claim 7, wherein the at least one characteristic of the perceiving audience identified by the one or more media asset profiles includes one or more characteristic selected from age group of the perceiving audience, education level of the perceiving audience, gender of the perceiving audience, income level of the perceiving audience, ethnicity of the perceiving audience, interests of the perceiving audience, home value of the perceiving audience, and geographic area of the perceiving audience.

9. The method of claim 8, wherein the one or more media asset profiles includes information about the distribution of one or more perceiving audience characteristics among the perceiving audience.

10. The method of claim 7, wherein the collected media asset perception data includes at least information regarding times of perceptions and durations of perceptions.

11. The method of claim 7, wherein generating one or more media asset profiles includes generating at least one manual media asset profile based at least in part on assumptions regarding characteristics of a perceiving audience, and generating, with the inferential engine associated with the inferential database, at least one automatic media asset profile based at least in part on the at least one manual media asset profile.

12. The method of claim 11, further comprising monitoring the media asset perception data over time, and updating, at least periodically, the at least one automatic media asset profile based at least in part on the collected media asset perception data.

13. The method of claim 12, further comprising assigning a confidence value to at least one perceiving audience characteristic in the one or more media asset profiles, and updating, at least periodically, at least one confidence value in the automatic media asset profiles based at least in part on the collected media asset perception data.

14. The method of claim 13, wherein the step of producing at least one target audience impressions report is further based at least in part on the confidence value assigned to the perceiving audience characteristics of the automatic media asset profiles.

15. A method of identifying one or more distributed media assets with which one or more advertisements may be associated to increase the number of impressions of the one or more advertisements by a target audience, the method comprising:
collecting media asset perception data from one or more media asset distributors and loading the media asset perception data into at least one inferential database;
generating one or more media asset profiles identifying at least one characteristic of a perceiving audience of the one or more distributed media assets and loading the one or more media asset profiles into the at least one inferential database;
collecting at least one target audience profile from an advertiser identifying at least one characteristic of a target audience for one or more advertisements and loading the at least one target audience profile into the at least one inferential database;
generating targeted advertising data with an inferential engine associated with the inferential database by identifying relationships in the at least one inferential database between the at least one target audience profile, the collected media asset perception data, and the one or more media asset profiles; and
producing at least one targeted advertising report based at least in part on the targeted advertising data identifying at least one targeted distributed media asset with which the advertiser may associate the one or more advertisements to increase the number of advertisement impressions by an audience having at least one characteristic at least substantially similar to those identified in the target audience profile.

16. The method of claim 15, wherein generating one or more media asset profiles includes generating at least one manual media asset profile based at least in part on assumptions regarding characteristics of a perceiving audience, and generating, with the inferential engine associated with the inferential database, at least one automatic media asset profile based at least in part on the at least one manual media asset profile.

17. The method of claim 16, further comprising monitoring the media asset perception data over time, and updating, at least periodically, the at least one automatic media asset profile based at least in part on the collected media asset perception data.

18. The method of claim 17, further comprising assigning a confidence value to at least one perceiving audience characteristic in the one or more media asset profiles, and updating, at least periodically, at least one confidence value in the automatic media asset profiles based at least in part on the collected media asset perception data.

19. The method of claim 18, wherein the step of generating targeted advertising data produces at least one list of targeted distributed media assets based on correlating the one or more media asset profiles, the confidence values of the automatic media asset profiles, and the at least one target audience profiles.

20. The method of claim 15, wherein the collected at least one target audience profiles includes significance data regarding the importance of one or more characteristics of the target audience to the advertiser, and wherein the step of generating targeted advertising data produces at least one list of targeted distribution media assets based on correlating the at least one characteristic in the one or more media asset profiles with the significance data of the at least one target audience profiles.

21. A method of identifying one or more media receivers to which one or more advertisements may be directed to increase the number of impressions of the one or more advertisements by a target audience, the method comprising:
collecting media asset perception data from one or more media asset distributors and loading the media asset perception data into at least one inferential database;
generating one or more media asset profiles identifying at least one characteristic of a perceiving audience of the one or more distributed media assets and loading the one or more media asset profiles into the at least one inferential database;
generating one or more media receiver profiles with an inferential engine associated with the at least one inferential database and loading the one or more media receiver profiles into the at least one inferential database, wherein the one or more media receiver profiles identify at least one characteristic of users of the one or more media receivers and are based at least in part on the collected media asset perception data and the one or more media asset profiles;
collecting at least one target audience profile from an advertiser identifying at least one characteristic of a target audience for one or more advertisements and loading the at least one target audience profile into the at least one inferential database;
generating receiver-targeted advertising data with the inferential engine based at least in part on relationships in the at least one inferential database between the at least one target audience profile and the one or more media receiver profiles; and
producing at least one targeted advertising report based at least in part on identifying at least one targeted media receiver to which the advertiser may direct the one or more advertisements to increase the number of advertisement impressions by an audience having at least one characteristic at least substantially similar to those identified in the target audience profile.

22. The method of claim 21, wherein the at least one characteristic of the perceiving audience identified by the one or more media asset profiles includes one or more characteristic selected from age group of the perceiving audience, education level of the perceiving audience, gender of the perceiving audience, income level of the perceiving audience, ethnicity of the perceiving audience, interests of the perceiving audience, home value of the perceiving audience, and geographic area of the perceiving audience.

23. The method of claim 22, wherein the one or more media asset profiles includes information about the distribution of one or more perceiving audience characteristics among the perceiving audience.

24. The method of claim 21, wherein the collected media asset perception data includes at least information regarding methods of receiving the distributed media asset, which information includes at least one type of information selected from networks on which the media asset was perceived, system operators from whom the media asset was received, television markets in which the media asset was received, types of media receiver through which the media asset was perceived, operating modes of the media receiver through which the media asset was perceived, and unique media receiver codes adapted to distinguish and identify the media receivers through which the media asset was perceived without revealing personally identifiable information.

25. The method of claim 21, wherein the collected media asset perception data includes at least information regarding times of perceptions and durations of perceptions.

26. The method of claim 21, wherein generating one or more media asset profiles includes generating at least one manual media asset profile based at least in part on assumptions regarding characteristics of a perceiving audience, and generating, with the inferential engine associated with the inferential database, at least one automatic media asset profile based at least in part on the at least one manual media asset profile.

27. The method of claim 26, further comprising monitoring the media asset perception data over time, and updating, at least periodically, the at least one automatic media asset profile based at least in part on the media asset perception data collected during monitoring.

28. The method of claim 26, further comprising monitoring the media asset perception data over time, and updating, at least periodically, the one or more media receiver profiles based at least in part on the media asset perception data collected during monitoring.

29. The method of claim 27, further comprising assigning a confidence value to at least one user characteristic in the one or more media receiver profiles, and updating, at least periodically, at least one confidence value in the one or more media receiver profiles based at least in part on the media asset perception data collected during monitoring.

30. The method of claim 29, wherein the step of producing at least one targeted audience advertising report is further based at least in part on the confidence value assigned to the user characteristics of the media receiver profiles.

31. The method of claim 21, wherein the collected at least one target audience profiles includes significance data regarding the importance of one or more characteristics of the target audience to the advertiser, and wherein the step of generating receiver-targeted advertising data produces at least one list of targeted media receivers based on correlating the at least one characteristic in the one or more media receiver profiles with the significance data of the at least one target audience profiles.

32. A method of verifying the effectiveness of a targeted advertising campaign associating one or more advertisements with one or more distributed media assets, the method comprising:
collecting media asset perception data from one or more media asset distributors and loading the media asset perception data into at least one inferential database;
generating one or more media asset profiles identifying at least one characteristic of a perceiving audience of the one or more distributed media assets and loading the one or more media asset profiles into the at least one inferential database;
collecting at least one target audience profile from an advertiser identifying at least one characteristic of a target audience for one or more advertisements and loading the at least one target audience profile into the at least one inferential database;
generating targeted advertising data with an inferential engine associated with the inferential database by identifying relationships in the at least one inferential database between the at least one target audience profile and the one or more media asset profiles;
producing at least one targeted advertising report based at least in part on the targeted advertising data identifying at least one targeted distributed media asset with which the advertiser may associate the one or more advertisements to increase the number of advertisement impressions by an audience having at least one characteristic at least substantially similar to those identified in the target audience profile
collecting advertisement placement data including information regarding relationships between at least one advertisement and one or more of the distributed media assets and loading the collected advertisement placement data into the at least one inferential database;
generating target audience impression data with the inferential engine by correlating at least the collected media asset perception data, the collected advertisement placement data, the collected at least one target audience profile, and the calculated media asset profiles; and
producing at least one target audience impressions performance report based at least in part on the target audience impression data and the targeted advertising report.
